(19) United States
(12) Patent Application Publication
(10) Pub. No.: US 2009/0177996 A1
(43) Pub. Date: Jul. 9, 2009

(54) Method and system for rendering and delivering network content

(76) Inventors: Dorian J. Hunt, Somerville, MA (US); Matthew R. Fulton, Cambridge, MA (US)

Correspondence Address: Kevin M. Farrell;Pierce Atwood, Suite 350, One New Hampshire Avenue, Portsmouth, NH, 03801, US

(21) Appl. No.: 12/008,233

(22) Filed: Jan. 9, 2008

(51) Int. Cl. G06F 3/14; G06F 15/16; G06F 17/30

(52) U.S. Cl. 715/788; 709/203; 707/10; 715/806; 707/E17.009

(57) ABSTRACT

In one embodiment, the present invention comprises a system and method for translating electronic data available through a computer network and transmitting that translated data to an electronic display device for accurate, non-obfuscated display. The present invention comprises providing a server in communication with a computer network that stores an executable software application therein for translating the electronic data for display. Next, the method comprises receiving a request for data at the server from a display device also in communication with the computer network. The server retrieves requested data from a source in communication with the computer network and translates the data into a format for display on the display device in accordance with the identified display characteristics and such that original content layout and interactive elements are therein preserved, and the server transmits the translated data display to the display device for electronic display.

### BACKGROUND OF THE INVENTION

1. Field of the Invention

The present invention relates generally to the field of delivering requested content to electronic display devices in wired and/or wireless communication with a computer network. More particularly, this invention relates to rendering network content and delivering that to computationally-limited devices in a content rich format that retains both original content layout, interactive elements, and onscreen navigation capabilities.

2. Discussion of Background Information

Manufacturers of electronic display devices constantly look for improved methods for displaying acquired content in a useful, device-compatible format. In particular, mobile display devices with limited processing capabilities and display limitations often require interpretation of downloaded data prior to display. Such interpretation tools often require robust software systems, signification drive size and/or significant processing power for proper presentation. Electronic devices lacking such processing capabilities and robust power sources often receive a cropped, distorted or limited representation of an original display.

For example, electrophoretic display (EPD), and related electronic paper (e-paper) and electronic reader (e-reader) devices are bistable electronic display devices that retain a written display even once a power source is terminated. These devices generally accommodate only the presentation of static documents or graphic formats, such as PDF, JPEG, or limited HTML/XML text-based files. Though some of these devices may connect to a computer network via wired and/or wireless communication means, they primarily download only static file content, such as PDF books from a central server. Standard web browsers are unfit for such platforms because of their associated processing burdens, power consumption needs and incompatibility with display hardware.

By design, these devices lack the marketable advantage of seamlessly connecting, browsing, interacting with and downloading internet and/or intranet content in a way that is sustainable for the hardware features and limitations. The process of creating and receiving e-reader content generally comprises the following sequence of events: A publisher creates a document or graphics file and converts and formats that document to an acceptable format for a device with specific limitations, (e.g. screen size, computational ability, color layout, etc.). The publisher then posts the document for download or emails the document to a content subscriber. Once the e-reader user receives the file and loads that file onto the device, the user is able to read and page through the image or document. The user, however, is unable to interact or connect to additional information.

Other electronic devices, such as cellular phones, personal digital assistants (PDAs), laptop computers, and personal computing devices, enable internet browsing on a mobile browser. These devices, however, provide less-than-optimal displays as compared to browsing on a desktop. Frequently, rendered pages appear skewed and altered beyond comfortable navigability. These mobile devices often present other limitations, such as those related to bandwidth and power consumption. Such limitations restrict a volume of data received by these devices, thereby decreasing performance and increasing user wait time. Acquired displays are often too big for the device display area, and text and other visual data appears altered or incomplete. Some inventions have addressed this problem by employing proxy servers that interpret content and transmit a partial display having a revised format. These proxy server inventions thereby lose original content layout and potentially eliminate valuable data, user-expected design, a publisher's preferred aesthetic and interactive elements. Other mobile browsing solutions aimed at preserving original format and allowing for standard browsing behavior require high computational abilities.

A great deal of reading and news and information gathering takes place via the Internet. With the existence and growing commercialization of e-paper and e-reader devices that replicate paper-based sources of information, a need therefore exists to enable delivery of web-based dynamic and interactive e-reader content that meets standards of user-accustomed Internet browsing behaviors. In other words, a need exists for an effective and operationally efficient system that recreates a desktop experience on an electronic display device having limited computational capabilities and display characteristics and that preserves original content layout, interactive elements and navigational capabilities during display on the electronic display device.

### SUMMARY OF THE INVENTION

The present invention is directed to a system and method for translating electronic data available through a computer network and transmitting that translated data to an electronic display device for display.

In one embodiment, the present invention comprises a computer-implemented method comprising providing a server in communication with a computer network. The server comprises a processor portion and a memory portion which stores an executable software application therein for translating the electronic data for display. Next, the method comprises receiving a request for data at the server from a display device also in communication with the computer network. The server may identify one or more display characteristics associated with the display device, such as display area dimensions, color capabilities, navigational interface, refresh frequency and processing capacity. Next, the server retrieves requested data from a source in communication with the computer network and translates the data into a format for display on the display device in accordance with the identified display characteristics and such that original content layout and interactive elements are therein preserved. Finally, the server transmits the translated data display to the display device for electronic display.

The method further comprises creating a map of interactive elements and pixel coordinates within the originally retrieved data display and creating a graphical display of the original data display that includes interactive form and link elements. The server delivers the map, graphics and interactive elements to the display device for merging. The system and method allows for rotating and zooming in the final merged display, as well as navigating links and forms in an approximation of a desktop browsing experience.

The present invention also comprises a system for translating an retrieved content available through a computer network for display at an electronic display device having limited processing capacity. The system comprises a server in communication with the computer network. The server comprises a processor portion and a memory portion that stores an executable software application. The executable software application translates the retrieved external content for display on the display device such that content layout and functionality of interactive elements are preserved.

The software application contains executable steps for receiving a request from a display device also in communication with the computer network and adapted for sending the server a request for an original electronic display, for identifying one or more display characteristics associated with the display device, for retrieving the requested original electronic display from a source also in communication with the computer network, for translating the original electronic display into a format for display on the display device in accordance with the identified display characteristics and such that original content layout of the original electronic display and any interactive elements therein are preserved, and for transmitting the translated display of the original electronic display to the display device for electronic display.

The contents of the request may include the description and/or location of an item of external content from an external content provider also in communication with a computer network. The server may translate or approximate the requested item for the purposes of optimal display on the requesting electronic display device. The software application also includes steps to transmit the approximated content to the original requesting electronic display device such that upon receipt, the electronic display device is capable of rendering the content in such a way as to maintain the interactivity of certain elements in the original content and ensure that the layout conforms to the layout expectations set forth by the external content provider.

### BRIEF DESCRIPTION OF THE DRAWINGS

FIG. 1 is a schematic showing an overview of an embodiment of the system of the present invention.

FIG. 2 is a schematic showing one embodiment of the method of the present invention.

FIG. 3 is an exemplary embodiment of a graphical user interface representing one aspect of an embodiment of the present invention.

FIG. 4 is an exemplary embodiment of a graphical user interface representing another aspect of the present invention.

FIG. 5 is an exemplary embodiment of a graphical user interface representing yet another aspect of the present invention.

FIG. 6 is an exemplary embodiment of a graphical user interface representing still yet another aspect of the present invention.

FIG. 7 is a schematic of an embodiment of another aspect of the system of the present invention.

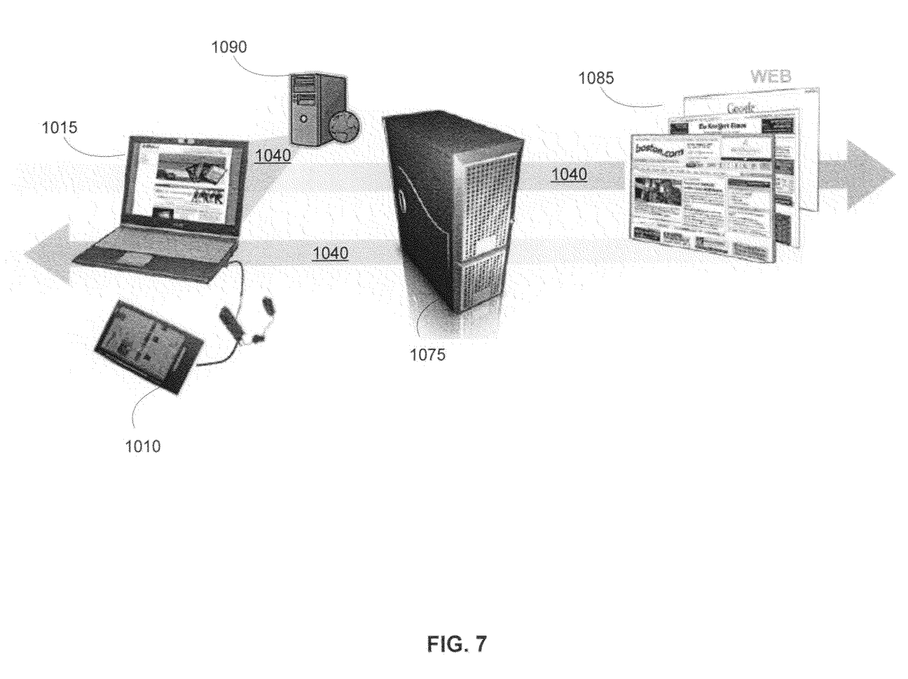

FIG. 8 provides one embodiment of representative data related to the system and method of the present invention as compared to prior art.

FIG. 9 is a schematic showing an overview of another embodiment of the system of the present invention.

### DETAILED DESCRIPTION

The present invention resolves the stated deficiencies of content delivery systems and methods, and recreates a desktop browsing experience on computationally limited and power limited mobile devices in wired and/or wireless communication with a computer network. Using server-side code, the present invention processes requested network content and renders that content in a display format that preserves intended content layout, including on screen aspect ratio, interactive elements and navigational capabilities during display on devices with limited display and processing capabilities. Various features and advantages of the present invention are described below with reference to several preferred embodiments and variations thereof. Those skilled in the art, however, will understand that alternative embodiments of the structures and methods illustrated herein may be employed without departing from the scope and principles of the described invention.

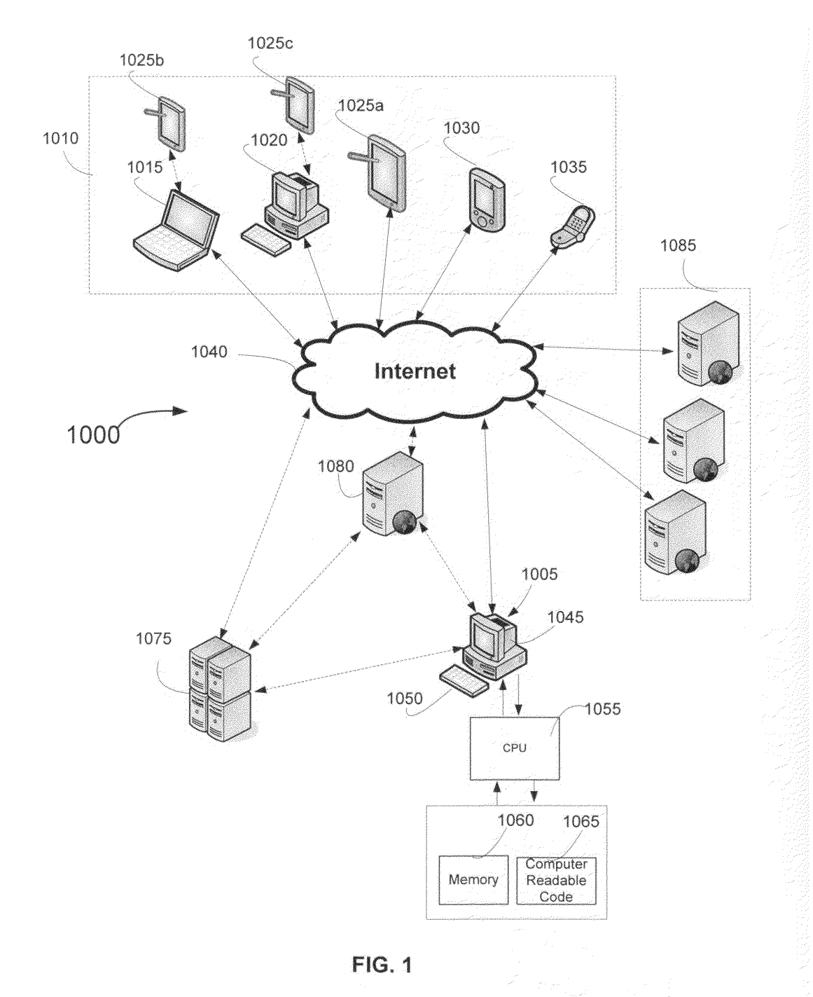

FIG. 1 depicts an overview of the system 1000 of the present invention. This system includes a service terminal, for example a server 1005, in communication with a plurality of user terminals 1010 that are communicating through a computer network. Because the present invention is available on a global level, and because the Internet 1050 is a global electronic communications network linking private and public networks and computers, the Internet 1050 is an appropriate medium for facilitating the present invention. The plurality of user terminals 1010 are preferably electronic display devices capable of communicating with the Internet 1040 directly or indirectly through wired or wireless means, devices such as but not limited to mobile and stationary devices including, for example, a laptop computer 1015, a stationary computer 1020, an electronic reader 1025a, 1025b, and 1025c, a personal computing device (PCD) 1030, and a cellular telephone 1035. This plurality of user terminals 1010 may communicate with the Internet 1040 via HTTP protocol and through wired and/or wireless means such as, but not limited to, Ethernet, IEEE standard 820.3 protocols, or through Bluetooth, WAP, TDMA, or CDMA. Preferably, the plurality of user terminals 1010 runs a local browser software and/or connectivity application thereon for communicating via the Internet 1040 and interacting with the organization terminal 1005.

The server 1005 is preferably a computer that comprises elements typical of a computing system. These elements may include items such as a monitor 1045, a keyboard 1050, a processor such as a central processing unit (CPU) 1055, and a memory storage area 1060. The memory storage area 1060 may be random access memory (RAM), or a combination of RAM and some removable memory storage means such as floppy disk, EPROMs, PROMs, or USB storage devices. The memory storage area 1060 contains computer readable code, or software 1065, for executing the processing steps of the present invention. In an alternative embodiment, the organization terminal 1005 optionally also may communicate with an application server 1075 that stores and executes the software portion 1065 and with a web server 1080. The optional web server 1080 communicates directly with the Internet 1040 and optionally hosts a user interface website that enables data synchronization and user registration of one of the plurality of electronic display devices 1010. The system of the present invention also comprises a plurality of originating sources 1085 also in communication with the Internet 1040 for providing original content to the server 1005 for translation.

Bi-directional routers (not shown) also may be disposed between each of the plurality of electronic display devices 1010 and the Internet 1050, and between the Internet 1050 and the organization terminal 1005. Additionally, the laptop computer 1015, stationary computer 1020, electronic reader 1025a, 1025b, and 1025c, personal computing device (PCD) 1030, and cellular telephone 1035 are shown by way of example only and an unlimited number of electronic display devices 1010 may communicate with the organization terminal 1005. Additional display device manufacturer terminals (not shown) or servers may exist between the server 1005 and the Internet 1040 such that a user of a user terminal 1005 must access the manufacturer server, which will then communicate with the server 1005.

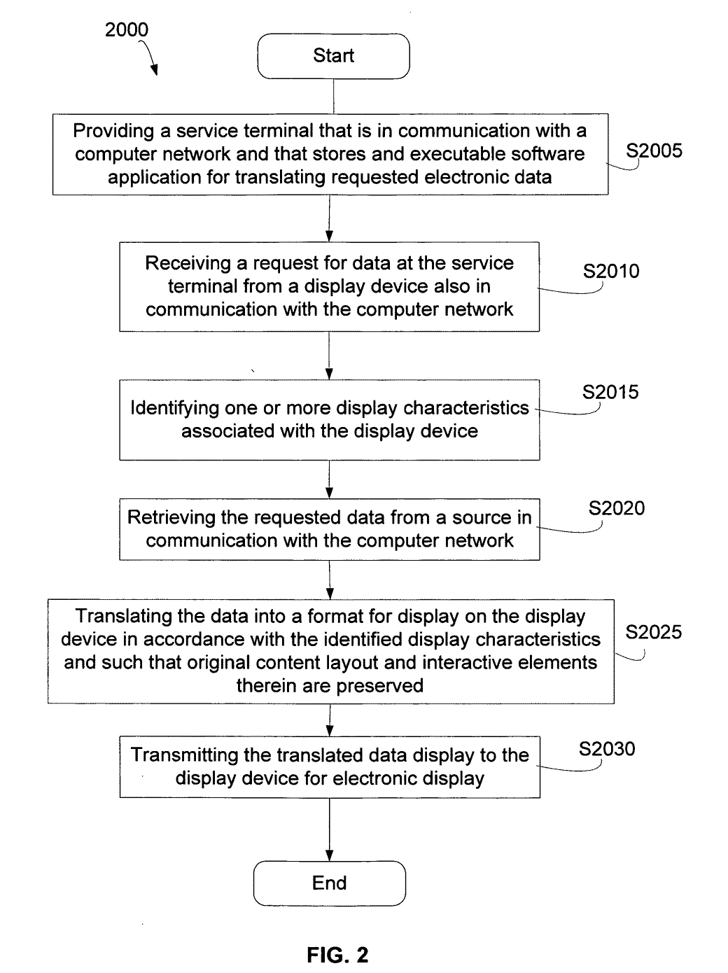

Turning now to FIG. 2, which depicts one embodiment of the method 2000 of the present invention, a first step S2005 for translating electronic data available through the a computer network, such as the Internet 1040 or an intranet, for display at a plurality of electronic display devices 1010 comprises providing the server 1005. The server 1005 is in communication with the computer network 1040 and comprises at least a processor portion 1055 and a memory portion 1060 that stores an executable software portion 1065 therein for translating the electronic data for display. A second step S2010 comprises receiving a request for electronic data at the server 1005 from one of the plurality of electronic display devices 1010 also in communication with the computer network 1040. Next, at a third step S2015, the present invention comprises identifying one or more display characteristics associated with the electronic display device 1010. At a fourth step S2020, the present invention comprises retrieving the requested electronic data from one or more originating sources 1085 in communication with the computer network 1040 such that a fifth step S2025 comprises translating the retrieved electronic data into a format suitable for display on the display device. That translation occurs in accordance with the identified display characteristics, and the original content layout of the electronic data and any interactive elements therein are preserved. In a final step S2030, the present invention comprises transmitting the translated electronic data to the electronic display device 1010 for electronic display. The following description further addresses these method steps, first step S2002 though final step S2030, in detail and in reference to additional, descriptive figures of embodiments of the system of the present invention.

Taking FIGS. 1 and 2 together, one embodiment of the present invention enables a plurality of electronic display devices 1010, including devices having limited processing ability, such as e-paper type electronic readers 1025a and related thin display hardware, to request electronic data available through a computer network 1040. The requested electronic data may comprise any or all types of electronic display data including but not limited to text, graphics and interactive forms and links. The electronic display device 1010 may be in constant or intermittent, direct or indirect, wired or wireless communication with the computer network. For example, an electronic reader 1025c may connect with a stationary computer 1020 via wired or wireless means, such as but not limited to USB or IR, for synchronizing electronic data transmitted by the server 1005 to the stationary computer 1020 via the computer network 1040. Once the electronic reader 1025c acquires display data, the electronic reader 1025c may travel to other locations at which updates and additional data may be available via wired or wireless connection with the computer network 1040. Additionally, the computer network 1040 may be the Internet, or a LAN or WLAN intranet.

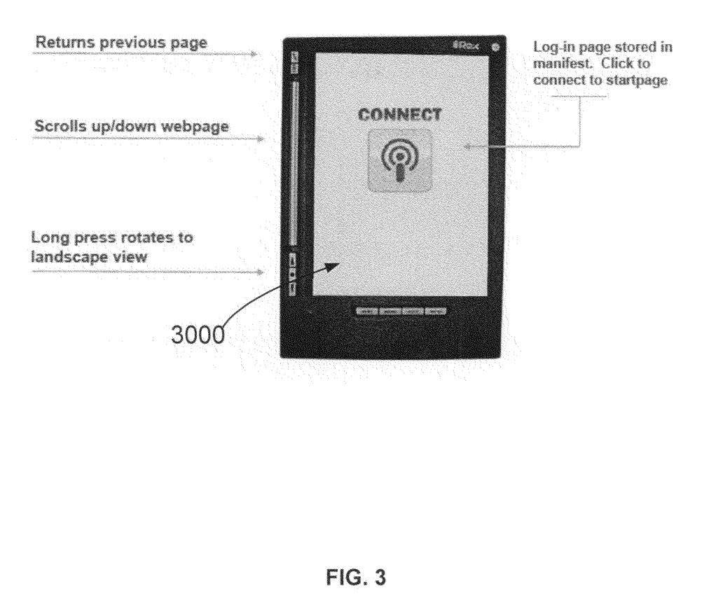

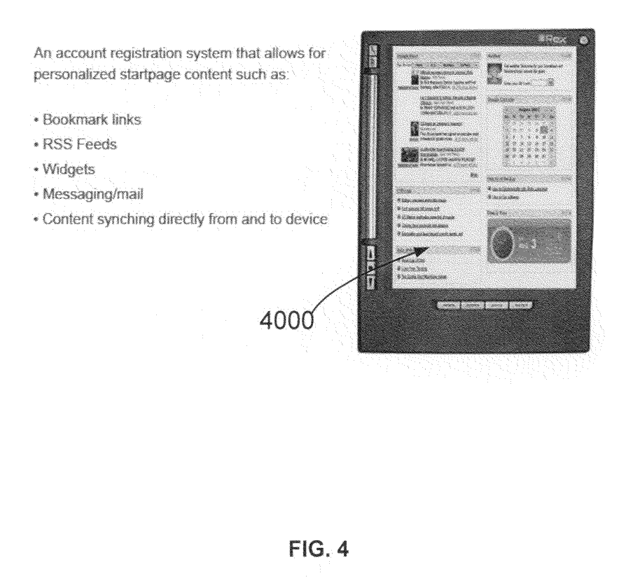

Turning to FIGS. 3 and 4, a connection screen 3000 and customized start page 4000 are shown for an electronic reader 1025a used in conjunction with one embodiment of the present invention. The electronic display device 1010, here an electronic reader 1025a, may have browser based software thereon for connecting with the computer network 1040, for placing requests. Because a markup language provides information about an electronic display including but not limited to structure and layout of display elements, the browser based software application also may merge elements of the transmitted translated data for display. The browser based software may comprise any type of markup language, such as but not limited to HTML, XHTML, DocBook, MathML, SVG, Open eBook, TEI, and XBRL.

Once the electronic device, such as the electronic reader 1025a, connects with the server 1005 via the computer network 1040, the browser based software enables presentation of a customizable start page 4000 that may include a log in screen (not shown). As FIG. 4 depicts, the customizable start page 4000 additionally may include items such as bookmark links, RSS feeds, messaging/mail links, and/or preferred widgets, such as time, weather, etc. Additionally, the start page may comprise a selection menu comprised of a link farm, or list of user favorite hyperlinks, such as, for example, preferred online newspapers, search engines, mail, etc. The start page also may comprise paid content positions and advertising. A user may select a hyperlink or banner available on the electronic device or a user may enter a search term or Uniform Resource Locator (URL) address to make a request for electronic data via the computer network 1040 using an appropriate protocol, for example HTTP. All of these preferences may be retained within an account registry maintained at the server 1005 or at another database, such as an electronic device manufacturer database. A user of an electronic display device 1010 may access a user interface (UI) for an account registry and specify device-specific preferences through the computer network 1040 from one of the plurality of electronic devices 1010.

Returning now to the embodiment of the present invention as shown in FIGS. 1 and 2, the server 1005 receives a request for electronic data via the computer network 1040. If the computer network 1040 comprises the Internet, a request may be, for example, in the form of a third party web page URL. If the computer network 1040 comprises an intranet, the request may be, for example, regularly scheduled polling by an electronic display device 1010, such as a thin, low-power sign. In one embodiment, the server 1005 receiving the request for electronic data comprises a content rendering server, such as the application server 1075 of FIG. 1, and the server additionally may comprise an internal memory portion 1060 and/or linked external memory portion such as a database server (not shown). The memory portion 1060 and/or database server may comprise at least one registry for receiving and storing information related to specific user accounts for a plurality of electronic display devices 1010. The server 1005 further may comprise a network server, such as a web server 1080 that hosts a UI webpage enabling user registration of a specific display device 1010 and associated user account preferences.

The at least one registry existing on the memory portion 1060 and/or database server may comprise a database of unique product identifiers and display characteristics associated with a plurality of electronic display devices 1010. Some display device characteristics associated with the plurality of electronic display devices 1010 may comprise the following non-exhaustive list of display characteristics: display area dimensions, color capabilities, navigational interface type, display refresh frequency, and device processing capacity. Each registered user account may link to the database such that the product identifiers and display characteristics accompany requests from a specific electronic display device 1010. The server 1005 may recognize a specific electronic display device 1010 based on a unique product identifier, which may be a manufacturer name and/or display device model number. Additionally, the server 1005 may recognize a specific electronic display device 1010 based on a hardware address, for example a Media Access Control address (MAC address) or Ethernet Hardware Address (EHA), or based on a user login associated with a particular electronic display device 1010.

In one embodiment, upon receiving a request for electronic data, a server 1005 running the software portion 1065 of the present invention executes commands therein such that the server 1005 retrieves requested data from one or more originating sources 1085 also in communication with the computer network 1040. The software portion 1065 then translates the requested electronic data and transmits that to the electronic display device 1010, allowing a user of the electronic display device 1010 to view a graphical representation of the originating content and to scroll through a display, clink on links, and enter search criteria, not unlike a user browning the web at a fully featured computer terminal. This translation, or approximation, of network content takes into account factors like aspect ratio, on screen movements, and other elements that enable the system and method of the present invention to mimic on an electronic display device 1010 what a user would see on a fully featured display device, such as a stationary computer 1020, having relatively greater processing capacity and display capabilities.

The requested electronic data may comprise one or more display elements selected from the group consisting of, but not limited to, plain text, interactive text, graphics, interactive form fields, audio, video, and animation elements. In one embodiment of the method of the present invention, the fifth step S2025 of translating the retrieved electronic data further comprises parsing and executing underlying code related to the electronic data according to code type such as but not limited to HTML, XHTML, CSS, and Javascript. The software portion 1065 also comprises commands for retrieving any external elements referenced by the underlying code, such as graphics and animations. In this embodiment, a custom user agent can render elements in conformance with existing HTML rendering platforms, such as HTML 4.1, the Trident rendering engine from Microsoft, or Mozilla's Gecko rendering engine. One skilled in the art will understand that these rendering platforms provided by way of example only and that the present invention operates in conjunction with any rendering engine.

Next, the server 1005 and executable software portion 1065 therein create and store to the memory portion 1060 a map of the interactive elements and their respective pixel coordinates within the retrieved content of the requested electronic data. The interactive elements are any code based elements, such as, for example, HTML and XHTML elements. The executable software portion 1065 arranges the third party content in conformance with the layout specified by the content originator. In one embodiment, for example, this layout may be specified by HTML. The software portion 1065 then assigns two-dimensional coordinates to the elements arranged in accordance with the layout specified by the content originator. These two-dimensional coordinates specify resultant positions of the elements after interpretation of the tags of the layout language(s) within the context of any surrounding content in which they may be embedded. The software portion 1065 then stores these two-dimensional coordinate positions in a database along with any associated descriptions and/or locations of the external content as originally specified by the requesting display device 1010. Additionally, in response to a request for any alternate views (e.g. scaled, zoomed, rotated), the executable software portion 1065 translates these coordinate positions so that once any alternate views render on the requesting display device, the graphical depictions of interactive elements transmitted correspond to coordinates that have been translated and delivered in the same payload.

The pixel coordinate map, however, may be a generic map that operates with any type of code based elements and that seamlessly integrates with any type of browser, or HTTP-enabled content interpreter, HTML or otherwise, running on the plurality of electronic display devices 1010. In one embodiment, the interactive elements are interactive elements, such as hyperlinks and/or simple and complex interactive entry forms for entering search criteria or login information. At the time of an initial request for a content by electronic display device 1010, the executable software portion 1065 constructs a local (server-side) copy of the directory structure and files of the originating content. This creates a functional mirror of the environment that exists on the third party content provider server. Subsequent requests for a resource that has already been requested at least once result in a rendering of the page that is served strictly from local sources, thus mitigating the speed effects of any networking bottlenecks that may exist between the proxy server and the third party content server. i.e. the one or more originating sources 1085.

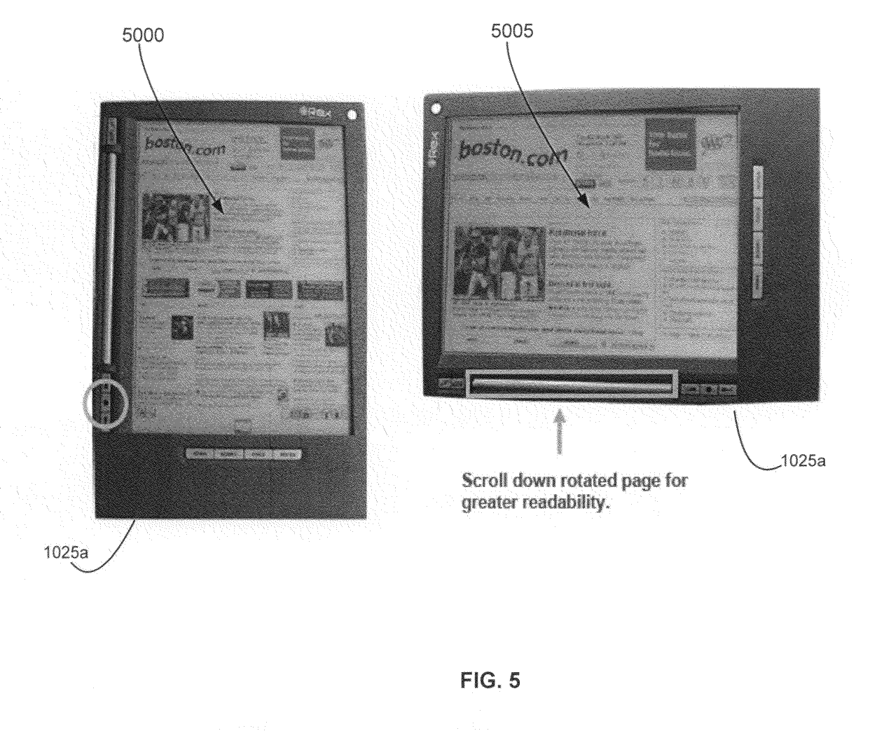

With a map of pixel coordinates for the interactive elements created and stored, the server next renders a first graphical display 5000 of the original electronic data display of the requested electronic data. In a preferred embodiment, this first graphical display 5000 is an uncompressed bitmap file. The method of the present invention further optionally may comprise rotating the first graphical display 5000 to create a two-dimensional, 90 degree pixel-by-pixel rotation of the first graphical display as shown in FIG. 5 and storing that to the memory portion as a second graphical display 5005. With the pixel coordinate map for at least first graphical display 5000, and preferably also a second graphical display 5005, created and stored to the memory portion 1060, the server 1005 then scales the dimensions of the first graphical display 5000 and optional second graphical display 5005 such that they are sized to fit with the display area dimensions of the electronic display device 1010, here shown as an electronic reader 1025a, and such that an original aspect ratio of the retrieved content from one or more of the plurality of sources 1085 remains unchanged. Additionally, the software portion 1065 of the present invention may minimize electronic display device load time and refresh rates by color reducing the first graphical display 5000 in accordance with color capabilities of the electronic display device 1010 and by clipping the first graphical display 5000 and optional second graphical display 5005 into display portions so as to prevent loading any invisible portions of the retrieved content, such as web page captures, into the translated display. The clipped portion of the translated content may comprise any portion of the original content as specified by the user through a device navigation control. Specifically, the user may specify a focus area for clipping to create a zoomed-in view of the graphic, and the server 1005 will provide the new graphic and interactive coordinate points associated with this new view.

Next, in a preferred embodiment of the present invention, the software portion 1065 deconstructs the first graphical display 5000 and the optional second graphical display 5005 into one or more portions that surround the interactive elements in the pixel coordinate map. The software portion 1065 then compresses the one or more portions of the first graphical display 5000 and optional second graphic display 5005 that surround the interactive elements and stores to the memory portion 1060 and/or database server 1070 the one or more retrievable compressed graphics files. In a preferred embodiment, the one or more compressed graphics files are lossless and may be any type of compressed graphics file that will display efficiently on a low processing device, such as but not limited ABO, GIF, JBIG, JBIG2, JPEG, JPEG-LS, JPEG 2000, PGF, PNG, SVG, MNG, Qbit Lossless Codec, TIFF, and/or WMPhoto files.

The memory portion 1060 and/or database server store the one or more compressed graphics files for the first graphical display 5005 and optionally store one or more compressed graphics files for the optional second graphical display 5005. Additionally, the memory portion 1060 and/or database server store the interactive elements, the interactive hyperlink and form elements, and external data related thereto, and a pixel coordinate map for identifying location of interactive elements among the one or more compressed graphics files that, when merged together, render a stable, interactive image of the retrieved content and interactive elements therein. The server 1005 then transmits the one or more compressed graphics files for the first graphical display 5000 and optional second graphical display 5005 to an electronic display device 1010 along with the interactive elements and pixel coordinate map. Using this technique, the server 1005 may provides more than just an image; The server 1005 also is capable of providing useful and functional interactive elements such as, for example, HTML rendered simple forms. Instead of providing merely a compressed image of retrieved content, the server 1005 also provides a mechanism for a user to interface with the retrieved content as intended to retrieve additional content. In other words, the server 1005 and software portion 1065 thereon enable user interaction such as searching and form navigation.

In one embodiment of the present invention, the server 1005 merges the compressed graphics files and interactive elements prior to transmitting the same to an electronic display device 1010. In a preferred embodiment, the electronic display device 1010 executes a second software application stored thereon for merging the one or more compressed graphics files with the one or more interactive elements in accordance with the pixel coordinate map. This second software application may operate independently of any specific markup language and may be designed to operate with a generic pixel coordinate map produced by the software portion 1065.

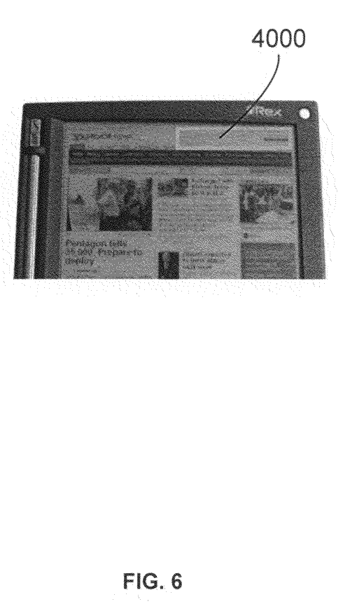

The present system and method thus enable users of a plurality of electronic display devices 1010 to seamlessly connect, browse, interact with and download rendered internet and/or intranet content to their electronic display device either through wired or wireless means. For example, a user requesting a daily newspaper on an electronic display device 1010, such as an electronic reader 1025a, may acquire a translated version of that electronic paper from the server 1005. The user may then select hyperlinked text within the translated display to retrieve additional rendered content from one or more linked originating content sources 1085. At a start page or during device registration, a user may specify a maximum number of link depths at which the server 1005 will translate and transmit requested electronic data in order to best utilize limited memory and computational capabilities of a particular electronic display device 1010. In an alternative embodiment, the software portion 1065 may suggest an optimum number of link depths for a particular electronic display device 1010 so as to optimize use of the limited memory and computational capabilities. The display device 1010 computational and memory characteristics may be identifiable automatically or through a user registration and log in process. A user then may browse translated electronic display content and navigate through active links included within the downloaded, rendered content. As shown in FIG. 6, interactive elements, such as search entry fields 6000, appear and function fully within a translated display, or optionally may be isolated for display on a unique display window (not shown) provided with a virtual keyboard.

The system and method of the present invention approximates an original display of electronic data and enables a user of a computationally-limited electronic display device 1010 to interact with the translated display much like interacting with the fully coded original display on a high processing power display device, such as a stationary computer terminal 1020. For example, a user of an electronic display device 1010 implementing the system and method of the present invention may zoom in on a translated display (through clipping navigation control), scroll, jump back and forth between rendered displays, refresh a rendered display, and bookmark displays. Additionally, one embodiment of the present invention enables offline content synchronization of an electronic display device 1010 having limited processing capabilities and limited display capabilities.

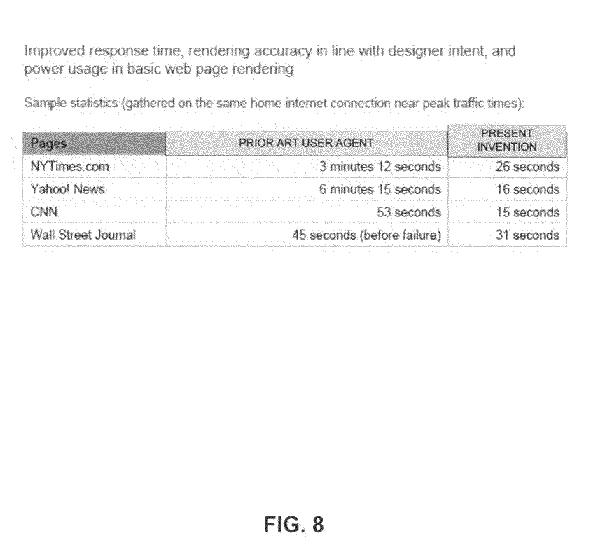

As FIG. 8 shows, one embodiment of the present invention may comprise electronic display data synchronizing directly from and to an electronic display device 1010, such as an electronic reader 1025b, in wired or wireless communication with another electronic display device 1010 having relatively greater processing and display capabilities, such as a laptop computer 1015. As shown here, the laptop computer 1015 may be in wired or wireless communication with a computer network 1040 and a manufacture server 1090, content rendering server 1075, and one or more originating sources 1085 also in communication with the computer network. The content rendering server 1075 may translate electronic display data according to the system and method of the present invention and then may transmit the translated electronic data to the laptop computer 1015. The laptop computer 1015 optionally may merge the graphics files and interactive elements transmitted thereto in accordance with a pixel coordinate map, and the electronic reader 1025b connected thereto then may upload the merged display elements via USB connection, Bluetooth, IR, or any number of wired or wireless communication means. Alternatively, the electronic reader 1025b may receive the graphics files, interactive elements and pixel coordinate map from the laptop computer 1015, and, by executing a second software application stored therein, independently merge the same elements into a completed translated display.

Content synchronization may include downloading a mesh of content at a certain number of linked depths that optimizes performance of a particular electronic display device 1010 having limited memory and computational capabilities. Rejoining an area with wireless and/or wired computer network links enables a mobile electronic display device 1010, such as the electronic reader 1025b, to reconnect with the content rendering server 1075 directly or indirectly through a display device manufacturer server 1090. A user thus again may download web pages, and a specified number of linked pages for offline reading when the user travels away from a Wi-Fi access point or a wired terminal, such as a stationary computer 1020, to which the electronic display device 1010 is connected. The mobile electronic display device 1010 then may seamlessly connect with the network once again when that option becomes available. A user interface allows the user of an electronic display device 1010 to specific link depths and to schedule synchronization of electronic data. The user interface may be hosted by an application server 1075, or a dedicated web server 1080, in communication with a computer network 1040. The user interface may be accessible through a portal hosted by the manufacturer server 1090, directly on the electronic display device start page, or both.

The system and method of the present invention provide an accurate approximation of original display content to electronic display devices 1010 having limited processing and display capabilities. Additionally, as FIG. 8 depicts, the software portion 1065 of the present invention executes the method steps of the present invention in an extremely stable and relatively fast manner. FIG. 8 presents a side-by-side comparison of prior art processing times against processing times associated with the system and method of the present invention for displaying rendered content. All trials incorporated an identical network connection and electronic display device 1010. The time lapses associated with the prior art represented a period between data request and system crash. None of the requested web pages loaded fully and the prior art system and method proved too unstable for completed rendering on an electronic display device 1010. The present invention provided completely stable, fully rendered displays within time periods of less than one minute, and in most trials, less than 30 seconds.

Because the present invention provides an extremely stable, quickly loadable display, the system and method may provide many uses beyond merely displaying content to electronic display devices with limited processing and display capabilities. For example, the present invention may present an unbreakable image mapped together with interactive elements within an SMTP email display. The present invention may apply to presenting displays on digital signage, public information terminals, and enterprise and industry-specific thin display tools. The present invention also may provide stable, quickly loading slide shows of “video” with or without audio components.

Additionally, in one embodiment, the software portion 1065 approximates video content for display on devices that are incapable of maintaining a refresh rate sufficient for delivering the video in the number frames per second specified by the original item of video. Using information determined in the assessment of the requesting device upon the original communication, the software portion 1065 approximates video in slides that capture the majority of meaningful pixel transitions in the original item of video. These slides accord with display refresh limitations of the electronic display device 1010. Items of video are segmented into individual graphical slides captured at intervals triggered, not only by the passage of time, but also by the percentage of pixel transitions in the original video from one image capture to the next.

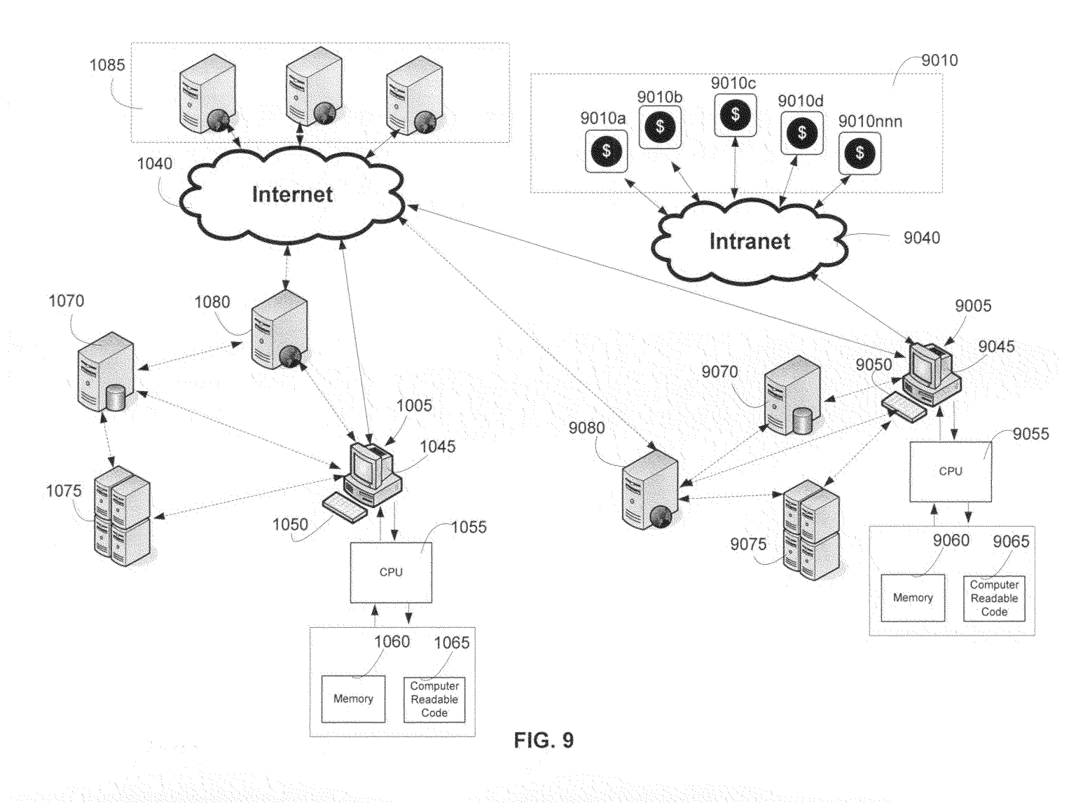

Turning now to FIG. 9, another embodiment of a system of the present invention enables presentation of rendered content on a plurality of display devices 9010 connected to a local server 9005 through a computer network, herein shown as an Intranet 9040. The local server 9005 is preferably a computer that comprises elements typical of a computing system. These elements include items such as a monitor 9045, a keyboard 9050, a processor such as a central processing unit (CPU) 9055, and a memory storage area 9060. The memory storage area 9060 may be random access memory (RAM), or a combination of RAM and some removable memory storage means such as floppy disk, EPROMs, PROMs, or USB storage devices. The memory storage area 9060 contains computer readable code, or software 9065, for executing the processing steps of the present invention. In an alternative embodiment, the memory storage area 9060 may include a database server 9070 for an added level of security and more expansive storage capacity. In an alternative embodiment, the organization terminal 9005 optionally also may communicate with an application server 9075 that stores and executes the software portion 9065 and with a web server 9080 that communicates directly with the Internet 1040 for obtaining electronic data from a plurality of external originating content sources 1085.

In this intranet embodiment, the plurality of display devices 9010 may be, for example, EPD signs disposed on store shelves. Each of the plurality of display devices 9010 is in wired or wireless communication with the computer network 9040 for requesting updated display data from the local server 9005 and/or for regularly polling for updated information stored at the memory portion 9060 or database server 9070 of the local server 9005. Also, in another embodiment, the local server 9005 could push translated electronic data out upon manual entry at the keyboard 1050 or at scheduled intervals. The local server 9005 optionally may communicate with a plurality of original content sources 1085 through a wired or wireless Internet connection, either directly or via an optional web server 9080 connection. A retail chain, for example, may use this embodiment of the present invention to simultaneously update pricing at a plurality of stores implementing a local server 9005, an intranet 9040 and a plurality of display devices 9010, as depicted in the exemplary embodiment of FIG. 9. The ability to eliminate or reduce a dependency on conventional, printed signage eliminates expensive print cost requirements and insures efficient, accurate presentation of updated data related to retail items, data such as pricing and/or graphics associated with each particular item or item manufacturer.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; Rather, the present invention extends to all functionally equivalent structures, methods and uses, such as are within the scope of the appended claims.

We claim:

1) A computer implemented method for translating electronic data available through a computer network for display at an electronic display device, the method comprising:
a) providing a server that is in communication with the computer network and that comprises a processor portion and a memory portion that stores an executable software application therein for translating the electronic data for display;
b) receiving a request for electronic data at the server from a display device also in communication with the computer network;
c) identifying one or more display characteristics associated with the display device;
d) retrieving the requested electronic data from a source in communication with the computer network;
e) translating the electronic data into a format for display on the display device in accordance with the identified display characteristics and such that original content layout of the electronic data and any interactive elements therein are preserved; and
f) transmitting the translated electronic data to the display device for electronic display.

2) The method of claim 1 wherein the electronic data comprises text, graphics, and/or interactive form and link elements.

3) The method of claim 1 wherein the electronic display device has limited processing ability.

4) The method of claim 3, wherein the electronic display device is a thin display and/or electronic paper device.

5) The method of claim 1 wherein the electronic display device is in wired or wireless communication with the computer network.

6) The method of claim 5 wherein the electronic display device is a mobile device.

7) The method of claim 1 wherein the computer network is the Internet and the request for data comprises a request for a third party web page specified by a requested URL.

8) The method of claim 1 wherein the computer network is an Intranet and the request for data comprises a regularly scheduled poll for data by the electronic display device.

9) The method of claim 1 wherein the said server comprises a content rendering server.

10) The method of claim 1 wherein the memory portion is an external database server and/or application server in communication with the server.

11) The method of claim 1 wherein the memory portion of the server further comprises a database of unique product identifiers and display characteristics associated with a plurality of electronic display devices.

12) The method of claim 11 wherein the step of identifying one or more display characteristics of the electronic display device further comprises receiving one or more unique product identifiers associated with the electronic display device.

13) The method of claim 12 further comprising the step of retrieving from the database one or more display characteristics associated with the one or more unique product identifiers.

14) The method of claim 13 wherein a unique product identifier is a MAC address.

15) The method of claim 13 wherein the unique product identifiers are a manufacturer name and display device model number.

16) The method of claim 13 wherein the unique product identifier is a user login established during a registration process for an electronic display device.

17) The method of claim 1, wherein the electronic display device characteristics comprise display area dimensions, color capabilities, navigational interface, refresh frequency and processing capacity.

18) The method of claim 1 wherein translating the requested electronic data further comprises parsing code related to electronic data contents according to code type and retrieving any external elements referenced by the code.

19) The method of claim 18 wherein the requested electronic data comprise one or more display elements selected from the group consisting of plain text, interactive text, graphics, interactive form fields, audio, video, and animation.

20) The method of claim 18 wherein types of code related to the display elements are HTML, XHTML, CSS and/or Javascript.

21) The method of claim 1, further comprising storing in the memory portion a map of anchor and/or interactive elements and their respective pixel coordinates within the original electronic data display.

22) The method of claim 21 wherein the anchor and/or interactive elements are HTML and/or XHTML code based elements.

23) The method of claim 21 wherein the anchor and/or interactive elements are interactive forms.

24) The method of claim 21, further comprising rendering a first graphical display of the original electronic data display.

25) The method of claim 24 wherein the first graphical display is a single, uncompressed bitmap.

26) The method of claim 24, further comprising scaling the dimensions of the first graphical display to be sized to fit within display area dimensions of the electronic the display device while retaining original aspect ratio of the original electronic data display.

27) The method of claim 24, further comprising minimizing electronic display device load time by color reducing the first graphical display in accordance with color capabilities of the display device.

28) The method of claim 24, further comprising optionally rotating the first graphical display in a two dimensional, 90 degree pixel-by-pixel rotation and storing that in the memory portion as an optional second graphical display.

29) The method of claim 28, further comprising clipping the first graphical display and optional second graphical display into display portions that prevents loading any invisible portions of the retrieved content into the translated display.

30) The method of claim 28, further comprising deconstructing the first graphical display and optional second graphical display into one or more portions that surround the anchor and/or interactive elements.

31) The method of claim 30, further comprising compressing the one or more potions of the first graphical display and optional second graphical display and storing those one or more portions in the memory portion as one or more compressed graphics files.

32) The method of claim 30, further comprising providing a zoomed in presentation of the one or more portions upon selection by a user.

33) The method of claim 30, further comprising storing the one or more portions as one or more lossless graphics files.

34) The method of claim 30, further comprising storing the one or more portions as one or more graphics files of the type chosen from the group consisting of ABO, GIF, JBIG, JBIG2, JPEG, JPEG-LS, JPEG 2000, PGF, PNG, Qbit Lossless Codec, TIFF, and WMPhoto.

35) The method of claim 30, further comprising merging the one or more compressed graphics files with the anchor and/or interactive elements according to the map of pixel coordinates, thereby completing a translated display of the original electronic data display.

36) The method of claim 35 wherein the electronic display device comprises stores and executes a second software application for merging the one or more graphics files and corresponding anchor and/or interactive elements according to their pixel coordinates, thereby completing the translated display.

37) The method of claim 1 wherein the electronic display device is running SMTP and the translated electronic data appears completely in an email message.

38) A system for translating retrieved content available through a computer network for display at an electronic display device having limited processing capacity, the system comprising:
a) server that is in communication with the computer network and that comprises a processor portion and a memory portion;
b) an executable software application stored in the memory portion for translating the retrieved content for display on the display device such that content layout and functionality of interactive elements are preserved, wherein the software application contains executable steps for:
i) receiving a request from the display device also in communication with the computer network and adapted for sending the server a request for retrieved content;
ii) identifying one or more display characteristics associated with the display device;
iii) retrieving the requested retrieved content from a source also in communication with the computer network;
iv) translating the retrieved content into a format for display on the display device in accordance with the identified display characteristics and such that original content layout of the retrieved content and selected interactive elements therein are preserved; and
v) transmitting the translated display of the retrieved content to the display device for electronic display.

39) The system of claim 38 wherein the computer network comprises an intranet and/or the Internet.

40) The system of claim 38 wherein the display device is a mobile device in wired or wireless communication with the computer network.

41) The system of claim 40 wherein the display device is an electronic paper device.

42) The system of claim 38, further comprising a stationary user terminal in wired or wireless communication with computer network such that the stationary user terminal communicates with the server to request a translated display of the retrieved content for display at the display device.

43) The system of claim 42 wherein the display device is in wired or wireless communication with the stationary user terminal such that the display device synchronizes with the stationary user terminal and uploads the translated display of the retrieved content from the user terminal according to user preferences and display device characteristics stored in a registry portion of the server.

44) The system of claim 38, further comprising a registry stored in the memory portion for receiving and storing display device characteristics and user preferences wherein user preferences may comprise an automatic synchronization schedule and specification of maximum number of uploaded link depths.
